(19) United States
(12) Patent Application Publication
(10) Pub. No.: US 2013/0298411 A1
(43) Pub. Date: Nov. 14, 2013

(54) GRIP JACKET, AND GRIP FOR CUTTING TOOL

(71) Applicant: Shozo Miyawaki, Hyogo (JP)

(72) Inventor: Shozo Miyawaki, Hyogo (JP)

(73) Assignee: UM: KOGYO INC., Hyogo (JP)

(21) Appl. No.: 13/980,931

(22) PCT Filed: Jan. 21, 2011
(86) PCT No.: PCT/JP2011/051059

§ 371 Date: Jul. 22, 2013

(51) Int. Cl. B25G 1/10

(52) U.S. Cl. CPC B25G 1/102
USPC 30/340

(57) ABSTRACT

Provided are a grip jacket which facilitates formation of a grip, is not easily separated, and is replaceable, and a grip for a cutting tool which exerts an excellent anti-slip effect, does not require insert molding, is low in cost, and is suitable for housing a folding blade as well. The grip jacket (10) to be mounted on a grip body to complete the grip for a cutting tool is made of an elastic body, and has a single-piece construction, with a pair of jacket side sections (110) interconnected by the intermediary of a jacket back section (120). Each jacket side section (110) has a thick-walled section (111) provided along an inner side of its open end (110c), and the thick-walled section (111) is provided with a fitting pocket (112) to be fitted with a fitting protrusion provided on the grip body side. The jacket back section (120) has, on its inner surface, a positioning protrusion (121) to be inserted into a fitting hole provided at the back section of the grip body for performing positioning.

### TECHNICAL FIELD

The present invention relates to a grip jacket, and a grip for a cutting tool.

### BACKGROUND ART

Conventionally, as a grip for a saw such as a hand saw, a grip using an elastic body as a part of a handle of the saw, for example, for preventing slippage or other purposes has been provided.

For example, Japanese Utility Model Application Publication No. 1-41577 (Patent Document 1) discloses a handle for a saw, wherein the handle (1) has an anti-slip elastic body (2) attached to a part of each side surface thereof.

Japanese Utility Model Application Laid-Open No. 6-39402 (Patent Document 2) discloses a handle for a saw, wherein elastic bodies (1), (1) are mounted on handle body halves (5), (5), respectively, before they are joined into one piece to form the handle.

Japanese Utility Model Application Publication No. 7-11925 (Patent Document 3) discloses a handle for a folding saw, wherein an elastic body is poured into a lower part of each hard section (6) of divided handle halves to form a soft section (7).

Japanese Utility Model Application Publication No. 7-42620 (Patent Document 4) discloses a handle for a saw, wherein a handle body (4) of an inverted U shape has its inner and outer surfaces covered with an elastic body (5), thereby forming a saw blade receiving groove (3) together.

Japanese Patent Application Laid-Open No. 2009-56543 (Patent Document 5) discloses a cutter grip, wherein divided grip bodies (210), (220) corresponding to the back and belly sides, respectively, are detachably fitted onto a grip section (120) of a cutter body (100) to form the grip.

### PRIOR ART DOCUMENTS

### Patent Documents

Patent Document 1: Japanese Utility Model Application Publication No. 1-41577
Patent Document 2: Japanese Utility Model Application Laid-Open No. 6-39402
Patent Document 3: Japanese Utility Model Application Publication No. 7-11925
Patent Document 4: Japanese Utility Model Application Publication No. 7-42620
Patent Document 5: Japanese Patent Application Laid-Open No. 2009-56543

### DISCLOSURE OF THE INVENTION

### Problems to be Solved by the Invention

In the case of the handle for a saw disclosed in Patent Document 1 above, although it was significantly improved as compared with the earlier saw handles using no elastic body, the elastic body (2) was provided only on a part of the outer surface of the handle (1) for the saw; the back and belly sections were not provided with such an anti-slip elastic body. Therefore, there were only limited effects in terms of improving ease of gripping, improving the feel when grasping, and preventing slippage.

In the case of the handle for a saw disclosed in Patent Document 2 above, both the handle body (5) and elastic body (1) have to be prepared as divided bodies. The handle bodies (5), (5) each covered with the elastic body (1) then have to be joined into one piece using screws or adhesives. Moreover, the part of the saw body (5) covered with the elastic body (1) is not so suitable for providing a saw blade housing groove (8).

In the case of the handle for a folding saw disclosed in Patent Document 3 above, the soft section (7) at the lower part of each of the hard sections (6) of the divided handle halves needs to be formed by insert molding. The mold as well as the insert molding operation required for manufacture leads to increased time and effort. Needless to say, as the halves are fixedly secured into one piece using screws, additional parts (screws) are necessary, and the screwing operation is also necessary.

In the case of the handle for a saw disclosed in Patent Document 4 above, it would be practically impossible to cover the inner and outer surfaces of the U-shaped handle body (4) with the elastic body (5) without using insert molding. In the case of using the insert molding, the elastic body (5) would likely be deposited thickly in the spaces surrounding the U-shaped handle body (4), leading to an increase in use of the raw material. Although it may be possible to decrease the use of the raw material by forming a cavity (8) in the space inside the U-shaped handle body (4), it produces other problems that a core and other parts are required, the mold construction becomes complicated, and the molding operation also becomes complicated.

In the case of the cutter grip disclosed in Patent Document 5 above, although the grip section (120) of the cutter body (100) can be entirely covered with the divided grip bodies (210), (220) without the use of screws or without performing insert molding or the like, the grip is not suitable for housing a folding blade.

In view of the foregoing, an object of the present invention is to solve the problems of the conventional techniques as described above by providing a grip jacket that facilitates formation of a grip, is not easily separated, and is detachable and replaceable, and a cutting tool grip that provides an excellent anti-slip effect by covering the entirety, does not require insert molding, is low in cost, and is suitable for housing a folding blade as well.

### Means for Solving the Problems

To accomplish the above object, a grip jacket according to the present invention has a first feature that it is a grip jacket detachably mounted on a grip body of a saw or other cutting tool to constitute a grip for the cutting tool, wherein

the grip jacket is made of an elastic body,

the grip jacket has a pair of jacket side sections to be mounted on outer surfaces of respective side sections of the grip body and a jacket back section to be mounted on an outer surface of a back section of the grip body,

the pair of jacket side sections and the jacket back section constitute a single-piece construction, with the jacket side sections having their one ends interconnected by the intermediary of the jacket back section and their other ends constituting open ends,

each of the jacket side sections has a thick-walled section extending along an inner side of the open end, the thick-walled section being provided with a fitting pocket to be fitted with a fitting protrusion provided on the grip body side, and

the jacket back section has an inner surface provided with a positioning protrusion to be inserted into a fitting hole provided at the back section of the grip body for performing positioning.

Further, a grip for a cutting tool according to the present invention has a second feature that it has the grip jacket having the above-described first feature mounted on a grip body of a saw or other cutting tool.

Further, the grip for a cutting tool according to the present invention has, in addition to the above-described second feature, a third feature that the grip body has a body back section constituting its back section and a pair of body side sections constituting its side sections, and the grip body is of a single-piece construction having a U-shaped cross section, with the pair of body side sections interconnected by the intermediary of the body back section,

a space between the pair of body side sections constitutes a folding blade housing groove,

the body side sections each have a fitting protrusion formed at its open end, the fitting protrusion being fitted to the fitting pocket arranged at the thick-walled section of the corresponding jacket side section of the grip jacket,

the body back section is provided with a fitting hole for receiving the positioning protrusion arranged at the jacket back section of the grip jacket, and

in the state where the grip jacket is mounted on the grip body, the grip jacket covers the outer surfaces of the body back section and the body side sections of the grip body, while as to the folding blade housing groove corresponding to an inner surface of the grip body, the grip jacket covers only the inner surface in the vicinity of a folding blade housing groove opening formed at an opening of the groove.

Furthermore, the grip for a cutting tool according to the present invention has, in addition to the above-described third feature, a fourth feature that the grip body is configured as a part of a handle body for a cutting tool made of metal, the handle body having a U-shaped cross section, the grip body constituting a prescribed region in a longitudinal direction of the handle body, and

the pair of body side sections of the grip body are configured to bulge laterally as compared with the handle body in the vicinity thereof, and the fitting protrusions arranged at the respective open ends of the body side sections are configured to be tilted inward toward each other, such that the folding blade housing groove opening is narrower than the folding blade housing groove at the back of the opening.

### Effects of the Invention

According to the grip jacket recited in claim 1, the grip jacket of a single-piece construction having the jacket back section and the pair of jacket side sections is used. The jacket back section of this grip jacket is placed on the back section of the grip body, and the positioning protrusion arranged on the inner surface of the jacket back section is inserted into the fitting hole arranged at the back section of the grip body. The jacket side sections of the grip jacket are placed on the outer surfaces of the respective side sections of the grip body. With each jacket side section being pulled and stretched, the fitting pocket on the thick-walled section extending along the inner side of the open end of that jacket side section is fitted with the fitting protrusion on the grip body side, whereby a grip for a cutting tool is obtained which has the grip jacket detachably mounted on the grip body of a saw or other cutting tool.

Accordingly, the grip jacket as a single article can be used to readily and reliably form the grip for a cutting tool.

As the grip jacket surely covers the whole outer surfaces of the back section, side sections, and belly section of the grip body, it is possible to obtain a cutting tool grip which provides a uniform feel of touch, is easy to grab, and has a great anti-slip effect.

For mounting the grip jacket on the grip body, the fitting pockets provided at the thick-walled sections extending along the inner sides of the open ends of the jacket side sections and the positioning protrusion provided at the jacket back section are used. Therefore, without the need of screws or adhesives, the grip jacket can be mounted on the grip body reliably, without displacement, and it will not fall off easily.

The grip jacket can be removed from the grip body. The grip jacket is thus replaceable.

According to the grip jacket recited in claim 1, it is of course possible to form the grip for a cutting tool without the need of a mold or complicated process steps required for insert molding.

Furthermore, as the grip jacket can be readily formed as a single-piece molded article which is thin and strong, it is possible to obtain a grip which can sufficiently save the raw material and is light in weight and high in strength, even compared to the one formed by insert molding.

According to the grip for a cutting tool recited in claim 2, the grip jacket recited in claim 1 is mounted on a grip body of a saw or other cutting tool.

To form the grip for a cutting tool, it is only necessary to mount the grip jacket prepared as another part. Therefore, the final assembly of the grip for a cutting tool is extremely simple, even compared to the case of using insert molding means. It is of course possible to receive an order first, and then mount a jacket of color and design according to the order, before shipment.

Further, according to the grip for a cutting tool recited in claim 2, the outer surface of the grip body is entirely covered with the grip jacket. This ensures good feel of touch, ease of grabbing, and excellent anti-slip effect.

Furthermore, according to the grip for a cutting tool recited in claim 2, the grip jacket is not made up of divided bodies, but has a single-piece construction. With the fitting pockets on the inner sides of the open ends of the jacket side sections and the positioning protrusion on the jacket back section, the grip jacket is mounted so as to be wound around the outer surface of the grip body which constitutes the framework of the grip.

Accordingly, it is possible to provide a cutting tool grip in which the grip jacket will not easily fall off or become displaced, without the use of screws or adhesives.

According to the grip for a cutting tool recited in claim 2, the grip jacket is removable. This allows replacement of the grip jacket, as required.

Further, according to the grip for a cutting tool recited in claim 3, in addition to the functions and effects obtained by the configuration recited in claim 2, the grip body on which the grip jacket is to be mounted is of a single-piece construction having a U-shaped cross section, with the pair of body side sections interconnected by the intermediary of the body back section, and the space between the pair of body side sections constitutes the folding blade housing groove. Further, the fitting protrusions provided at the open ends of the body side sections of the grip body are fitted to the fitting pockets arranged on the inner sides of the open ends of the jacket side sections of the grip jacket. Still further, the fitting hole at the body back section of the grip body is fitted with the positioning protrusion at the jacket back section of the grip jacket.

In the state where the grip jacket is mounted on the grip body, the grip jacket covers the outer surface of the grip body, while as to the inner surface of the grip body, the grip jacket covers only the inner surface in the vicinity of the folding blade housing groove opening. That is, a major part of the inner surface of the grip body is uncovered with the grip jacket, contributing to the reduction in weight as a whole. This can also reduce the use of the raw material.

The area around the folding blade housing groove opening is covered with the grip jacket, which can naturally lessen the impact at the time of insertion of the folding blade.

Furthermore, according to the grip for a cutting tool recited in claim 4, in addition to the functions and effects obtained by the configuration recited in claim 3, the body side sections of the grip body are configured to bulge laterally as compared with the handle body near the body side sections. In the state where the grip jacket is mounted on the grip body, the above configuration can further favorably prevent displacement of the jacket side sections mounted on the bulging body side sections.

The fitting protrusions arranged at the open ends of the bulging body side sections are configured to be tilted inward toward each other. This can prevent the fitting pockets of the grip jacket fitted with the fitting protrusions from being disengaged easily.

In addition, with the fitting protrusions configured to be tilted inward toward each other, the opening width of the folding blade housing groove opening is made narrower than the width of the folding blade housing groove at the back of the opening. This configuration, together with the grip jacket covering the folding blade housing groove opening, makes it possible to surely prevent the blade housed in the folding blade housing groove from accidentally slipping out of the folding blade housing groove.

### BRIEF DESCRIPTION OF THE DRAWINGS

FIG. 1 is a front view of a grip jacket according to an embodiment of the present invention.

FIG. 2 is a plan view of the grip jacket according to the embodiment of the present invention.

FIG. 3 is a right side view of the grip jacket according to the embodiment of the present invention.

FIG. 4 is an end view, taken along A-A, of the grip jacket according to the embodiment of the present invention.

FIG. 5 is a developed view of the grip jacket according to the embodiment of the present invention.

FIG. 6 is a front view of a handle body having a grip body as its part according to the embodiment of the present invention.

FIG. 7 is a plan view of the handle body having the grip body as its part according to the embodiment of the present invention.

FIG. 8 is a right side view of the handle body having the grip body as its part according to the embodiment of the present invention.

FIG. 9 is a left side view of the handle body having the grip body as its part according to the embodiment of the present invention.

FIG. 10 is a cross sectional view, taken along B-B, of the handle body having the grip body as its part according to the embodiment of the present invention.

FIG. 11 is a front view of a grip for a cutting tool according to the embodiment of the present invention.

FIG. 12 is a plan view of the grip for a cutting tool according to the embodiment of the present invention.

FIG. 13 is a right side view of the grip for a cutting tool according to the embodiment of the present invention.

FIG. 14 is a left side view of the grip for a cutting tool according to the embodiment of the present invention.

FIG. 15 is a cross sectional view, taken along C-C, of the grip for a cutting tool according to the embodiment of the present invention.

### MODES FOR CARRYING OUT THE INVENTION

A grip jacket and a grip for a cutting tool using the grip jacket according to an embodiment of the present invention will be described with reference to the following drawings.

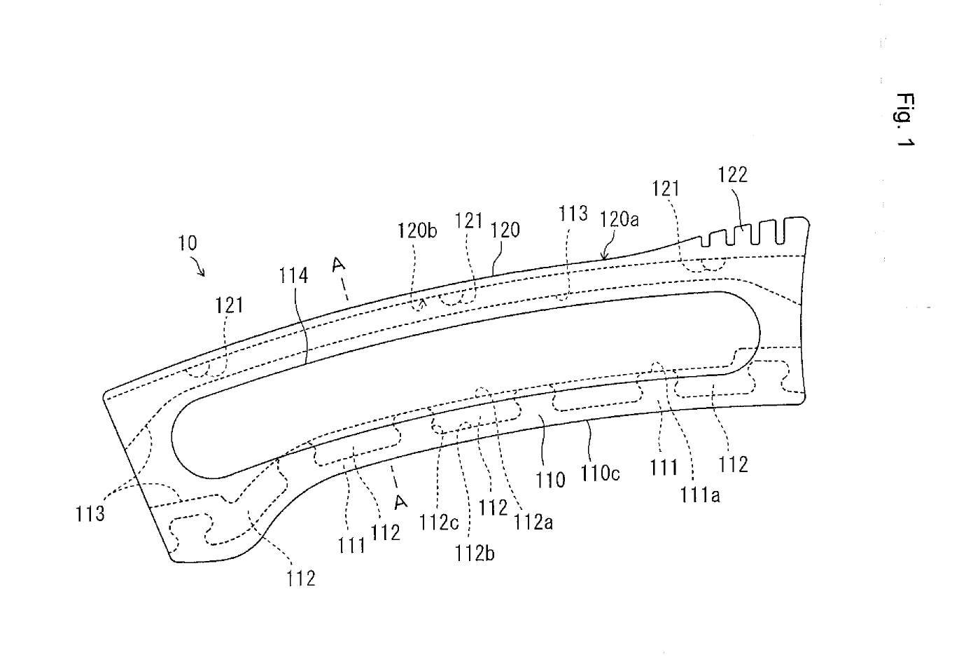

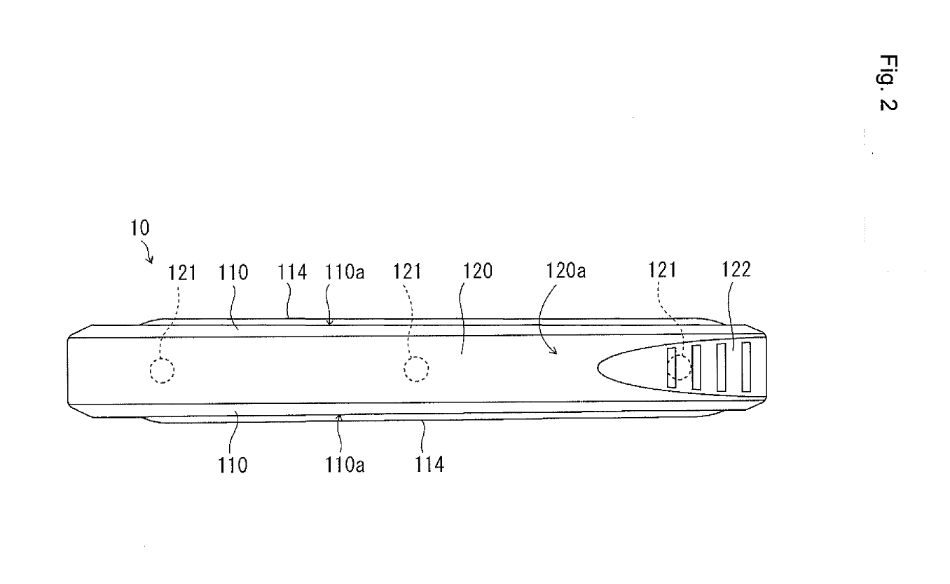

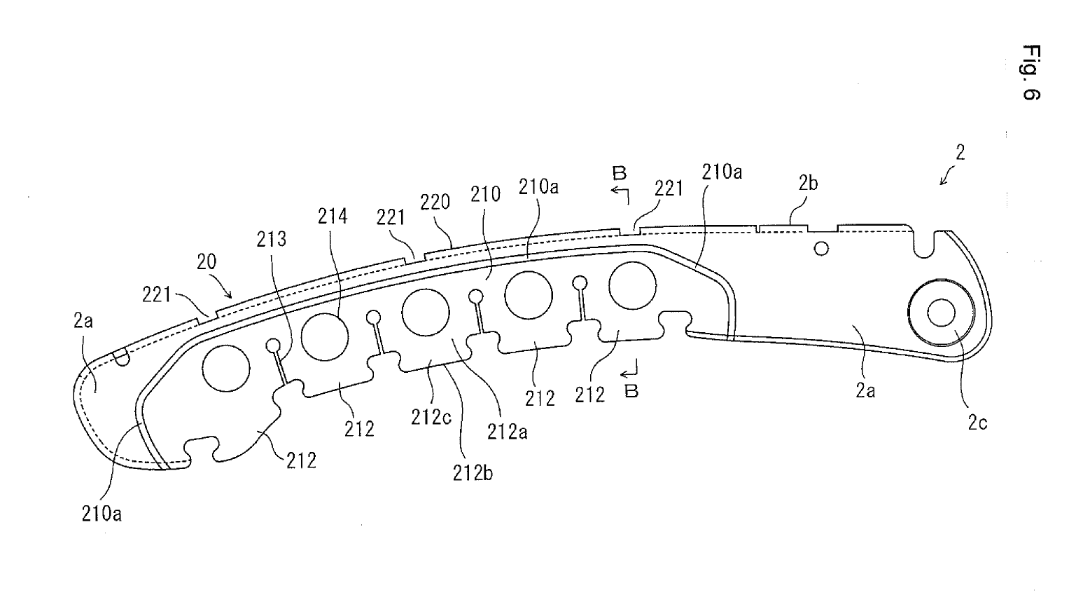

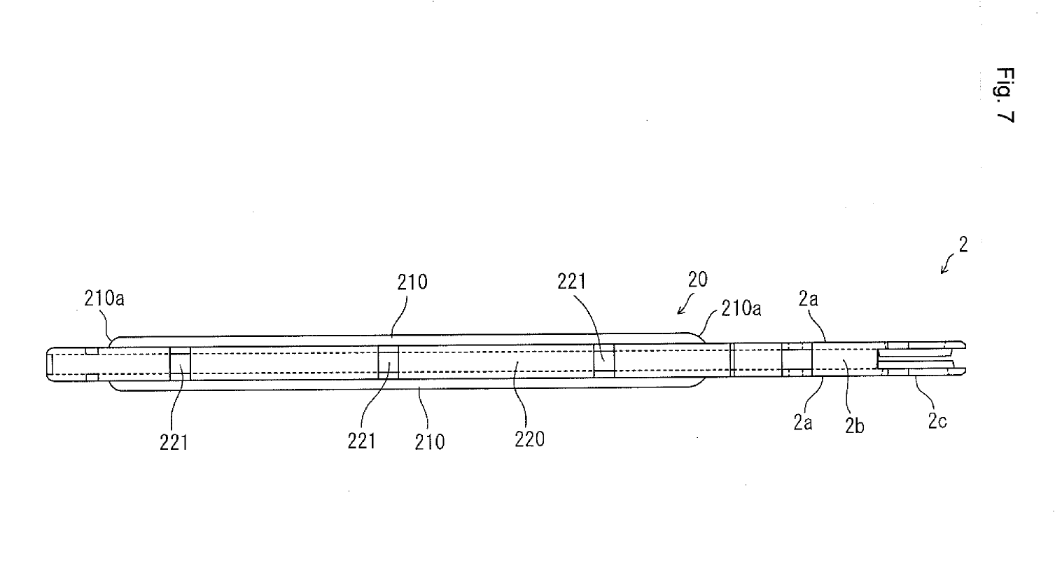

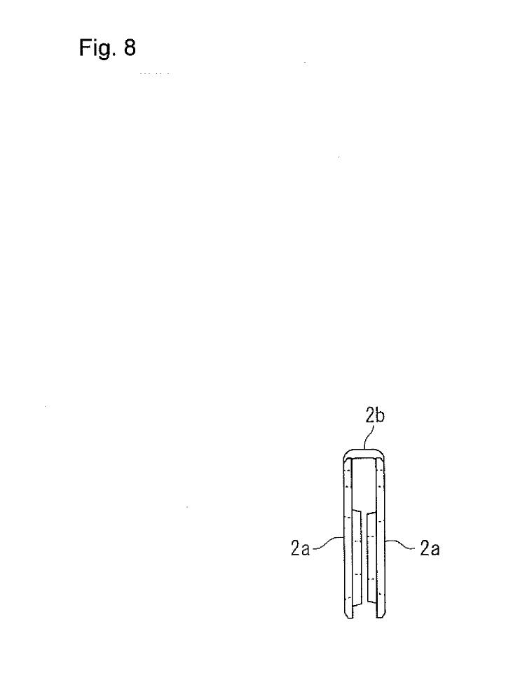

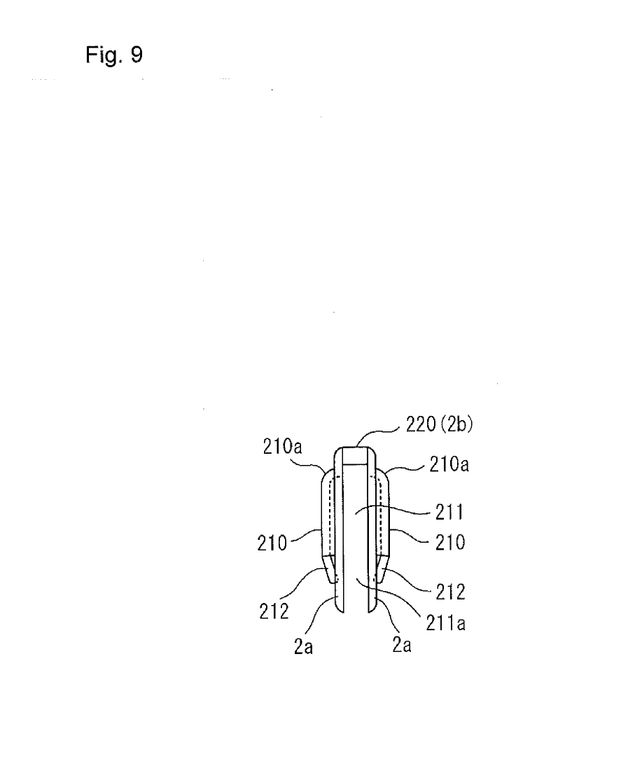

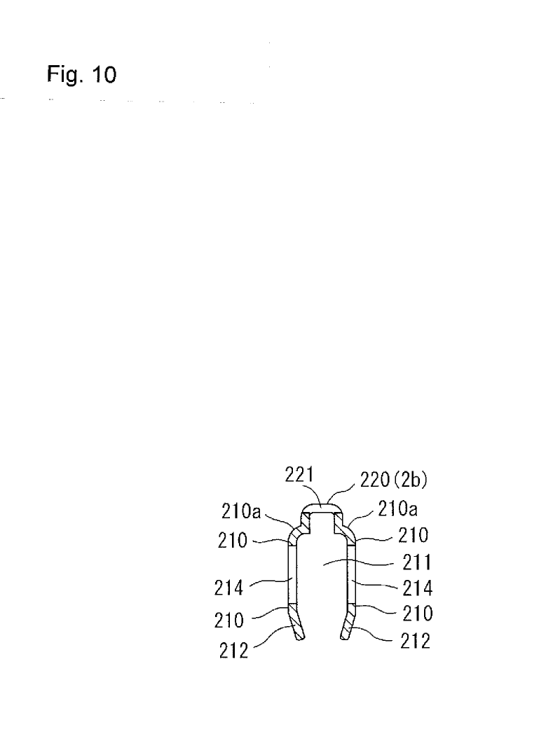

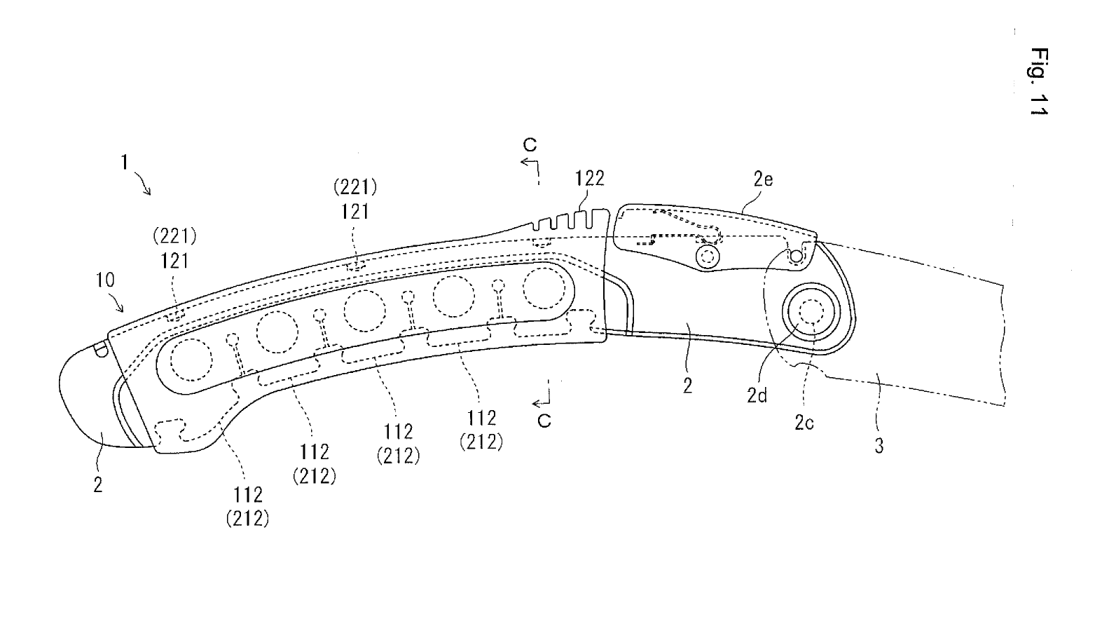

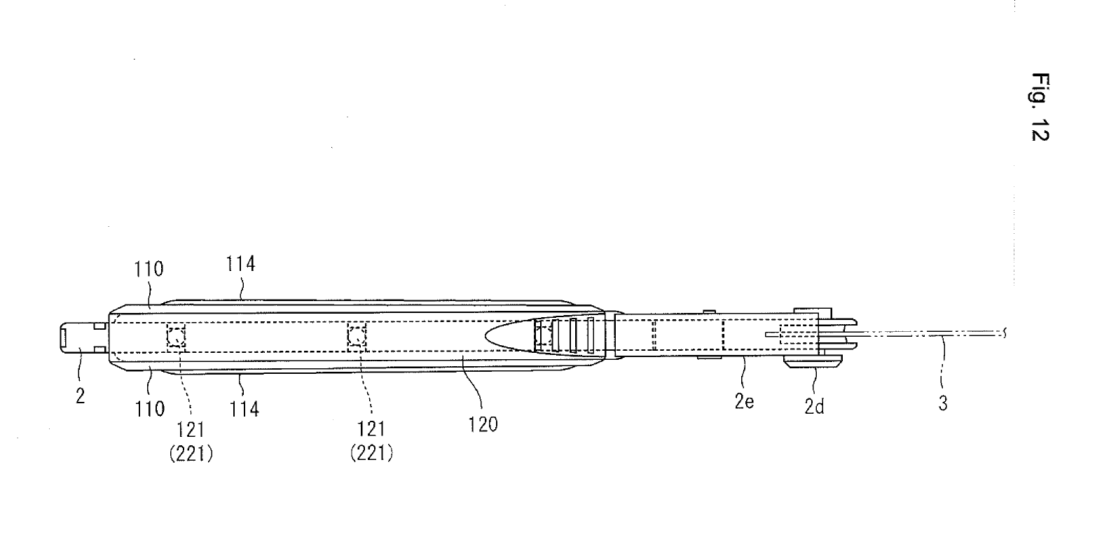

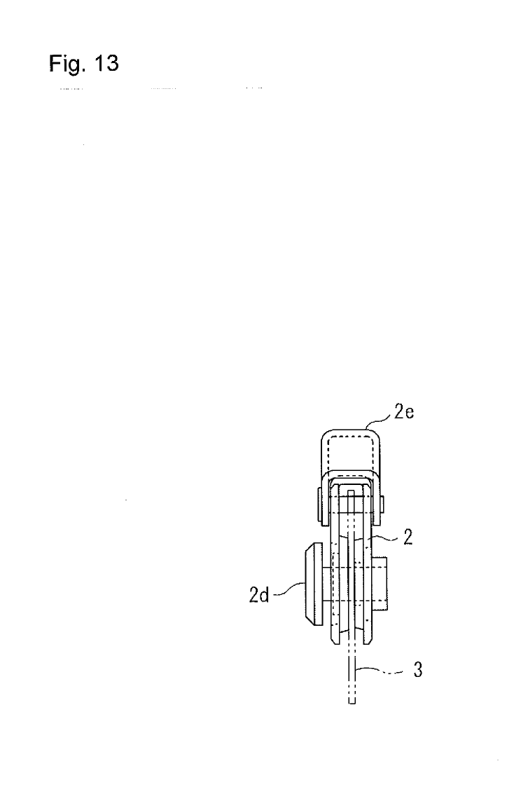

A grip jacket 10, shown in FIGS. 1 to 5, is mounted on a grip body 20 provided at a handle body 2, shown in FIGS. 6 to 10, so that a grip 1 for a cutting tool, shown in FIGS. 11 to 15, is completed.

The grip 1 for a cutting tool according to the present invention will be actually described as a grip for a saw. Further, the grip jacket 10 will be actually described as a grip jacket for a saw.

The grip jacket 10 is made of an elastic body, such as rubber having elasticity, synthetic resin having elasticity, etc. That is, as the elastic body, it has at least deformability and recoverability. At the time of mounting on the grip body 20, the grip jacket 10 can be stretched as appropriate, and once mounted, the grip jacket 10 fits just on the grip body 20 by virtue of its recoverability.

This grip jacket 10 is sized to correspond to the size of the grip body 20 on which the jacket is to be mounted, and is curved to correspond to the curve of the grip body 20.

The grip jacket 10 is configured such that its curve in the longitudinal direction becomes steeper near its distal end. The steeper curve ensures that the hand grabbing the grip will not slip off easily in the longitudinal direction of the grip.

The grip jacket 10 has a pair of jacket side sections 110, 110, and a jacket back section 120.

The grip jacket 10 is of a single-piece construction having the pair of jacket side sections 110, 110 and the jacket back section 120. More specifically, the grip jacket 10 has the single-piece construction, with the jacket side sections 110, 110 having their common ends interconnected by the intermediary of the jacket back section 120 and their other ends constituting open ends 110c.

The jacket side sections 110, 110 are of the same shape; they are each formed as an elongated cantilevered section.

At each open end 110c of the pair of jacket-side sections 110, 110, i.e. at each of the pair of ends located at the belly side of the jacket opposite to the jacket back section 120, a thick-walled section 111 is provided along the inner side of the open end 110c.

The portions near the open ends 110c, 110c are slightly curved inward toward each other.

The thick-walled section 111 extends along the inner side (inner surface 110b) of the slightly inwardly curved open end 110c, with an approximately constant width (depth) from the open end 110c and over almost the entire length in the longitudinal direction of the open end 110c.

The presence of the pair of thick-walled sections 111, 111 is important, not only for forming a fitting pocket 112, which will be described next, but also for adjusting the size of a folding blade housing groove opening 211a, which is an entrance to a folding blade housing groove 211, which will be described later.

The thick-walled section 111 is provided with the fitting pocket 112, which is formed by making use of the thickness of the thick-walled section 111. A plurality of fitting pockets 112 are formed in the longitudinal direction. In the present embodiment, five fitting pockets 112 are formed.

Each fitting pocket 112 has a receiving opening 112a, which opens inward toward an inner step section 111a of the thick-walled section 111, i.e., toward the step section 111a located opposite to the open end 110c.

The fitting pocket 112 has its inner bottom section 112b formed approximately parallel to the open end 110c.

The fitting pocket 112 has its inner side section 112c formed in a mushroom shape slightly bulging from the receiving opening 112a.

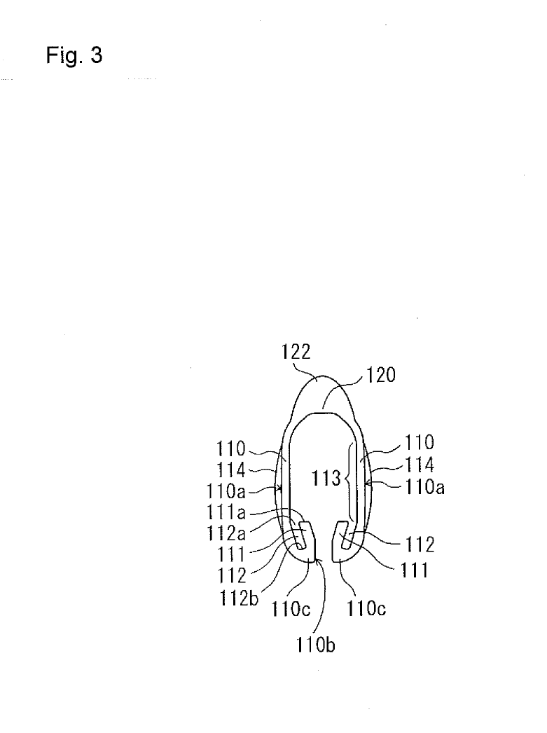

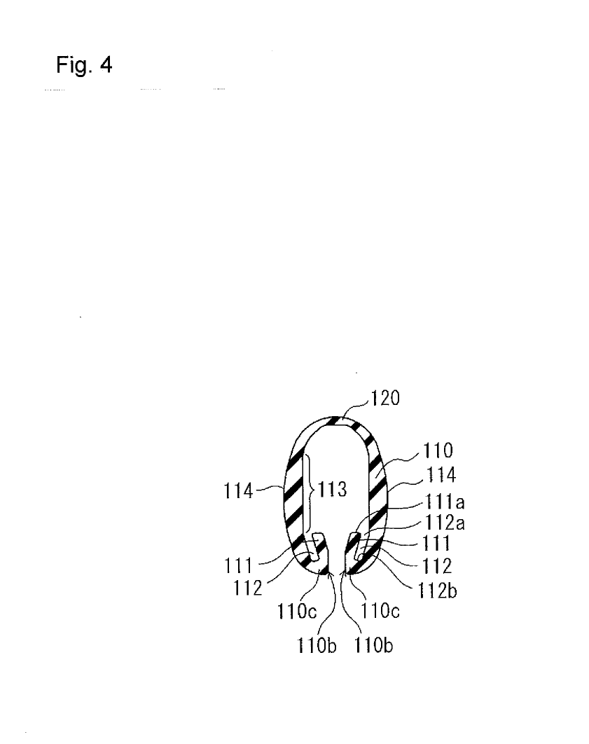

As shown in FIGS. 3 and 4, the fitting pockets 112, 112 formed on the respective sides to face each other are configured such that they are tilted inward to decrease the gap therebetween from their receiving openings 112a toward their inner bottom sections 112b.

Of the plurality of fitting pockets 112 formed in the thick-walled section 111, the fitting pocket 112 at the distal end (the leftmost one of the five fitting pockets 112 shown in FIG. 1) is configured such that it is tilted greatly with respect to the direction of the other fitting pockets 112. Making the direction of the fitting pocket 112 at the distal end different from the direction of the other fitting pockets 112 is advantageous in that, when the grip jacket 10 is mounted on the grip body 20 and fitting protrusions 212, 212, . . . are fitted to the fitting pockets 112, 112, . . . , as will be described later, the grip jacket 10 as a whole can be prevented from being separated easily.

The inner surface 110b of each of the jacket side sections 110 has a slightly depressed concave section 113, which is provided at the center of the inner surface 110b to extend along the longitudinal direction. The concave sections 113 are configured to slightly fit with the corresponding body side sections 210 of the grip body 20, which will be described later, to prevent displacement or separation of the grip jacket 10 as well as generation of wrinkles on the jacket.

Further, the outer surface 110a of each of the jacket side sections 110 has a slightly bulging section 114, which is provided at the center of the outer surface 110a to extend along the longitudinal direction. The bulging sections 114 allow the grip to fit (conform) to the palm when a user grabs the grip.

The jacket back section 120 is a portion to be mounted on a body back section 220, described later, of the grip body 20.

The jacket back section 120 has a positioning protrusion 121 provided on an inner surface 120b thereof.

One positioning protrusion 121 may be formed at the center of the inner surface 120b, or two or more positioning protrusions 121 may be formed at the center, at prescribed intervals along the longitudinal direction. In the present embodiment, three positioning protrusions 121 are formed.

The positioning protrusion 121 is fitted into the corresponding fitting hole 221 provided at the body back section 220 of the grip body 20, as will be described later, to ensure accurate positioning of the grip jacket 10 and the grip body 20, while preventing displacement thereof.

The outer surface 120a of the jacket back section 120 has its front end portion raised up to form an anti-slip section 122. This anti-slip section 112 serves to prevent the hand grabbing the grip from slipping off forward.

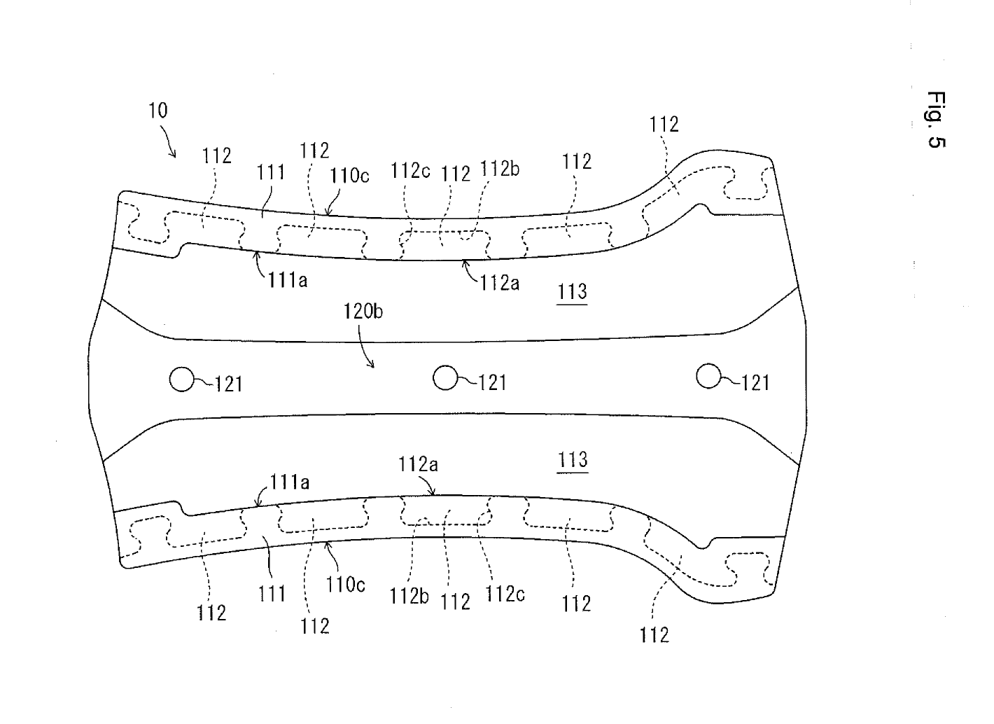

The grip jacket 10 can readily be developed into the state as shown in FIG. 5 by hand. In the normal state, however, the grip jacket 10 has a U shape in cross section, with the jacket back section 120 serving as a bridging section.

The grip body 20 refers to a region of the handle body 2 onto which the grip jacket 10 is mounted. The grip body 20 is provided, as a part of the handle body 2, at a prescribed region in the longitudinal direction. In the present embodiment, the region excluding the front and back end portions of the handle body 2 constitutes the grip body 20. A saw blade 3 is attached to the front portion of the handle body 2.

The saw blade 3 may be replaced with a sickle, machete, kitchen knife, knife, or other cutting tool. In the present invention, the cutting tool is a concept that includes the saw blade 3. The back end portion of the handle body 2 is excluded from the region to be covered with the grip jacket 10, and therefore, in a precise sense, it is not part of the grip body 20.

The grip body 20 is made of stainless steel, although other steel material, metal material, hard plastic material may be used.

The grip body 20 has a pair of body side sections 210 and a body back section 220. The grip body 20 is of a single-piece construction having a U-shaped cross section, with the body side sections 210, 210 interconnected by the intermediary of the body back section 220. In the state where the body back section 220 is located at the top, as shown in FIGS. 6 to 10, the U shape of course becomes an inverted U shape.

The handle body 2, a part of which constitutes the grip body 20, also has a pair of side sections 2a, 2a corresponding to the pair of body side sections 210, and a back section 2b corresponding to the body back section 220. The handle body 2 is of a single-piece construction having a U-shaped cross section, with the side sections 2a, 2a interconnected by the intermediary of the back section 2b. The handle body 2 also has a U shape in cross section.

The body back section 220 of the grip body 20 has a width identical to that of the back section 2b of the handle body 2. The body back section 220 of the grip body 20 and the back section 2b of the handle body 2 are configured to continue in a straight line, with the same width with each other.

On the other hand, the pair of body side sections 210, 210 of the grip body 20 are configured to bulge laterally as compared with the handle body 2. More specifically, while the body side sections 210, 210 of the grip body 20 and the side sections 2a, 2a of the handle body 2 are configured as wall sections continuous with each other, each body side section 210 of the grip body 20 has a sloped step section 210a through which the body side section 210 bulges laterally from the handle body 2.

The laterally bulging body side sections 210, 210 of the grip body 20 are each engaged with, and slightly fitted to, the corresponding one of the concave sections 113, 113 on the inner surfaces 110b of the pair of grip jacket side sections 110. As a result, the pair of jacket side sections 110 of the grip jacket 10 are mounted on the body side sections 210 of the grip body 20 tightly, thereby preventing displacement or separation without the use of adhesives.

The space formed between the pair of body side sections 210, 210 of the grip body 20 serves as a folding blade housing groove 211.

At an open end of each of the body side sections 210, 210 of the grip body 20, a fitting protrusion 212 is provided.

The fitting protrusion 212 is to be fitted to the fitting pocket 112 of the grip jacket 10 described above. Two or more (in the present embodiment, five) fitting protrusions 212 are formed in the longitudinal direction of each of the body side sections 210, 210 of the grip body 20.

In practice, the open end of each body side section 210 is cut to form dovetail grooves at appropriate intervals, such that the remaining portions serve as the fitting protrusions 212.

Each fitting protrusion 212 has a shape corresponding to that of the fitting pocket 112. More specifically, the fitting protrusion 212 has a base section 212a corresponding to the receiving opening 112a of the fitting pocket 112, a flat tip end section 212b corresponding to the inner bottom section 112b of the fitting pocket 112, and a mushroom-shaped outer side section 212c, slightly bulging from a base section 212a, corresponding to the inner side section 112c of the fitting pocket 112.

When each fitting protrusion 212 is inserted into the corresponding fitting pocket 112, the fitting pocket 112 receives the inserted fitting protrusion 212 while being elastically deformed. Once the entirety of the fitting protrusion 212 has entered the fitting pocket 112, the fitting protrusion 212 is retained in the pocket, and will not easily slip off.

Each fitting protrusion 212 may have a shape identical to that of the fitting pocket 112 to which it will be fitted. It is of course possible to make the fitting protrusion in a shape similar to or analogous with that of the fitting pocket.

Of the fitting protrusions 212, the fitting protrusion 212 at the distal end is configured such that it is tilted with respect to the direction of the other fitting protrusions 212, as in the case of the fitting pocket 112 described above. As the fitting protrusion 212 at the distal end is made more tilted as compared with the other fitting protrusions 212, once the grip jacket 10 is put on and the fitting protrusions 212, 212, . . . are fitted to the fitting pockets 112, 112, . . . , the grip jacket 10 as a whole can be prevented from being separated easily, although it is of course detachable.

The fitting protrusions 212, 212 formed on the respective sides of the folding blade housing groove 211 to face each other are configured such that they are tilted inward to decrease the gap therebetween from their base sections 212a toward their tip end sections 212b. As the tilted fitting protrusions 212 are fitted to the similarly tilted fitting pockets 112, the effect of preventing the grip jacket from falling off can further be improved. Therefore, together with the other configurations for preventing fall-off of the grip jacket, the present invention ensures that the grip jacket 10 is reliably mounted on the grip body 20, without the need of using adhesives or the like.

The gap width between the tip end sections 212b of the fitting protrusions 212, 212 located at the respective sides to face each other is made approximately equal to the gap width between the pair of body side sections 2a, 2a of the handle body 2.

In the state where the fitting pockets 112 of the grip jacket 10 are fitted with the fitting protrusions 212, the gap between the open ends 110c, 110c of the pair of jacket side sections 110, 110 of the mounted grip jacket 10 serves as the folding blade housing groove opening 211a, which is the entrance to the folding blade housing groove 211.

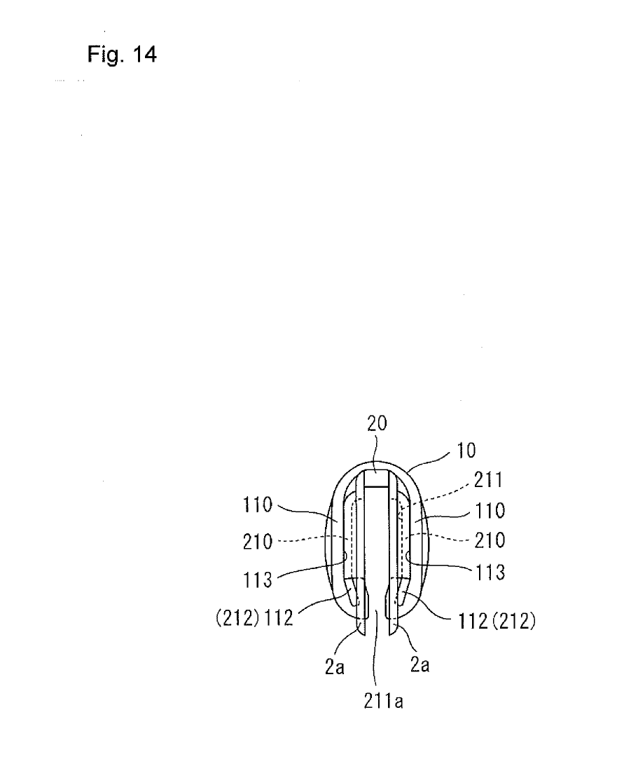

The folding blade housing groove opening 211a is made further narrower in width than the gap between the pair of body side sections 2a, 2a of the handle body 2 (see FIG. 14), such that the folding blade housing groove opening 211a guides the folding blade into the folding blade housing groove 211, and also prevents the saw blade 3, that has been folded and housed in the folding blade housing groove 211, from easily slipping out of the folding blade housing groove 211.

In order for the folding blade housing groove opening 211a to have a desired opening, the gap width between the fitting protrusions 212, 212 and the thicknesses of the portions of the grip jacket 10 to be mounted on the surfaces of the fitting protrusions 212, 212 are set to appropriate sizes in advance, in accordance with the thickness of the folding blade.

The body back section 220 of the grip body 20 is provided with a fitting hole 221.

One or more fitting holes 221 can be formed in correspondence with the positioning protrusion(s) 121 formed at the jacket back section 120 of the grip jacket 10. In order to ensure sufficiently accurate positioning, the fitting hole 221 preferably has a shape into which the positioning protrusion 121 can be fitted tightly, although a certain looseness may be provided for ease of mating them together.

As the positioning protrusion 121 of the grip jacket 10 is inserted and fitted into the fitting hole 221 of the grip body 20, they are positioned in right place, while displacement is prevented.

It is noted that one or more slits 213 may be provided at a lower half portion of each of the pair of body side sections 210 of the grip body 20, for the purpose of providing some elasticity.

Further, for reducing the weight of the grip body 20 side, one or more through holes 214 may be provided as well.

In the present embodiment, at the front portion of the handle body 2, a pivotal support section 2c for rotatably supporting the saw blade 3 or other blade, and means necessary for holding the blade in a usable state are arranged.

FIGS. 11 to 15 show the grip 1 for a cutting tool according to the embodiment of the present invention. This grip 1 for a cutting tool is completed as the grip jacket 10 is mounted on the grip body 20 of the handle body 2.

For mounting the grip jacket 10, first, the jacket back section 120 of the grip jacket 10 is placed on the body back section 220 of the grip body 20. At this time, each positioning protrusion 121 on the jacket back section 120 is inserted and fitted into the corresponding fitting hole 221 on the body back section 220. Next, with one of the jacket side sections 110 of the grip jacket 10 being pulled and stretched, the fitting pockets 112 on the one jacket side section 110 are fitted with the corresponding fitting protrusions 212 on one of the body side sections 210 of the grip body 20. Similarly, the fitting pockets 112 on the other jacket side section 110 are fitted with the corresponding fitting protrusions 212 on the other body side section 210. In this manner, mounting of the grip jacket 10 on the grip body 20 is finished and, hence, the grip 1 for a cutting tool is completed.

On the grip 1 for a cutting tool, the saw blade 3 is rotatably attached to the pivotal support section 2c of the handle body 2, by a pin 2d or the like. A locking means 2e for locking the saw blade 3 at a prescribed use position is also attached.

It is of course possible to attach a cutting tool other than the saw blade 3. The grip 1 for a cutting tool according to the present invention is intended for use with the cutting tools other than the saw blade 3 as well.

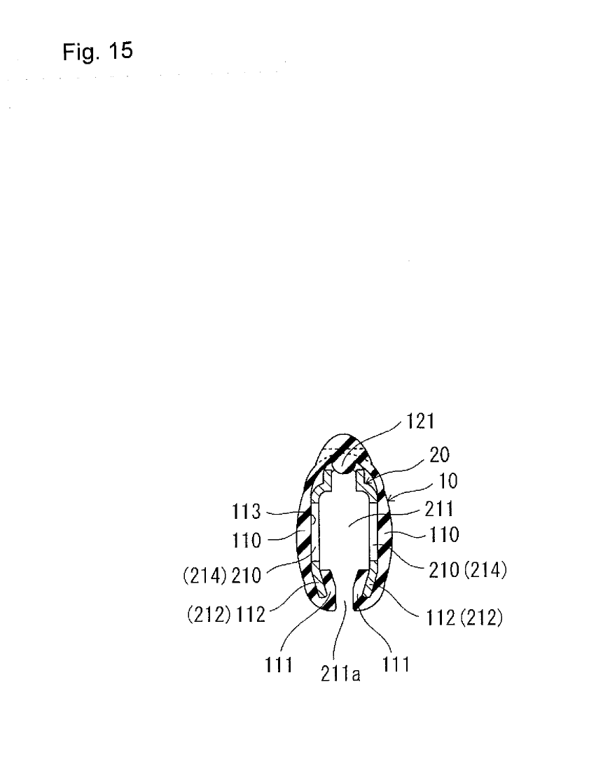

Referring to FIGS. 14 and 15, the folding blade housing groove opening 211a of the folding blade housing groove 211 for receiving and housing the folded saw blade 3 therein is formed by covering only the inner surfaces near the lower open ends of the body side sections 210 of the grip body 20, with the grip jacket 10, by a constant narrow width. In this manner, the folding blade housing groove opening 211a is configured to be narrower than the folding blade housing groove 211 and further narrower than the gap between the pair of body side sections 2a, 2a of the handle body 2.

As such, by making use of the grip jacket 10 mounted, the folding blade housing groove opening 211a is made to have a constant width still narrower than the gap width between the body side sections 2a, 2a of the handle body 2. This prevents the blade folded and housed in the folding blade housing groove 211 from easily slipping out of the folding blade housing groove 211, and also facilitates taking the blade out of the groove.

On the other hand, the folding blade housing groove 211 extending to the back from the folding blade housing groove opening 211a is not covered with the grip jacket 10, and is made to be wider than the gap between the body side sections 2a, 2a of the handle body 2.

With the folding blade housing groove 211 set wider than the gap between the pair of body side sections 2a, 2a of the handle body 2, it is readily possible to make the body side sections 210 of the grip body 20 bulge laterally as compared with the handle body 2. The bulging body side sections 210 of the grip body 20 are fitted to the concave sections 113 on the inner surfaces of the jacket side sections 110 of the grip jacket 10, thereby allowing the grip jacket 10 to be mounted more tightly, without displacement.

In addition, setting the folding blade housing groove 211 wider than the gap between the pair of body side sections 2a, 2a of the handle body 2 is advantageous in that another mechanism can be arranged in the wide groove space, as required.

Incidentally, if insert molding were used for covering the grip body with resin or rubber to form a cutting tool grip, the rubber or resin melted during the molding would inevitably penetrate into the groove of the grip body and any other portions constituting the space communicating with the outside, thereby filling the space. It was therefore practically impossible to arrange any mechanical structure in the space formed in the grip body for communication with the outside. That is, even if such a mechanical structure were disposed, the melted rubber or resin would penetrate into the mechanical structure or block the communication with the outside during the later insert molding. The mechanical structure would therefore be unable to exert any function or effect to the outside; it would be out of service.

In the cutting tool grip 1 according to the present invention, it is only necessary to mount a preformed grip jacket 10 on the jacket body 20, without the need of insert molding. Accordingly, even when a mechanical structure is arranged at the back of the folding blade housing groove 21 in advance, melted rubber or resin will not penetrate into the mechanical structure or block the communication with the outside in the later process step. As a result, the mechanical structure can be used without fail,

### INDUSTRIAL APPLICABILITY

The grip for a cutting tool according to the present invention has an industrial application in manufacture of a saw or other cutting tool. Further, the grip jacket has an industrial application in manufacture of a grip for a cutting tool.

### DESCRIPTION OF THE REFERENCE CHARACTERS

1 grip for cutting tool
2 handle body
2a body side section
2b body back section
2c pivotal support section
2d pin
2e locking means
10 grip jacket
20 grip body
110 jacket side section
110a outer surface
110b inner surface
110c open end
111 thick-walled section
111a inner step section
112 fitting pocket
112a receiving opening
112b inner bottom section
112c inner side section
113 concave section
114 bulging section
120 jacket back section
120a outer surface
120b inner surface
121 positioning protrusion
122 anti-slip section
210 body side section
210a sloped step section
211 folding blade housing groove
211a folding blade housing groove opening
212 fitting protrusion
212a base section
212b tip end section
212c outer side section
213 slit
214 through hole
220 body back section
221 fitting hole

What is claimed is:

1. A grip jacket detachably mounted on a grip body of a saw or other cutting tool to constitute a grip for the cutting tool, wherein
the grip jacket is made of an elastic body,
the grip jacket has a pair of jacket side sections to be mounted on outer surfaces of respective side sections of the grip body and a jacket back section to be mounted on an outer surface of a back section of the grip body,
the pair of jacket side sections and the jacket back section constitute a single-piece construction, with the jacket side sections having their one ends interconnected by the intermediary of the jacket back section and their other ends constituting open ends,
each of the jacket side sections has a thick-walled section extending along an inner side of the open end, the thick-walled section being provided with a fitting pocket to be fitted with a fitting protrusion provided on the grip body side, and
the jacket back section has an inner surface provided with a positioning protrusion to be inserted into a fitting hole provided at the back section of the grip body for performing positioning.

2. A grip for a cutting tool, having the grip jacket according to claim 1 mounted on a grip body of a saw or other cutting tool.

3. The grip for a cutting tool according to claim 2, wherein
the grip body has a body back section constituting its back section and a pair of body side sections constituting its side sections, and the grip body is of a single-piece construction having a U-shaped cross section, with the pair of body side sections interconnected by the intermediary of the body back section,
a space between the pair of body side sections constitutes a folding blade housing groove,
the body side sections each have a fitting protrusion formed at its open end, the fitting protrusion being fitted to the fitting pocket arranged at the thick-walled section of the corresponding jacket side section of the grip jacket,
the body back section is provided with a fitting hole for receiving the positioning protrusion arranged at the jacket back section of the grip jacket, and
in the state where the grip jacket is mounted on the grip body, the grip jacket covers the outer surfaces of the body back section and the body side sections of the grip body, while as to the folding blade housing groove corresponding to an inner surface of the grip body, the grip jacket covers only the inner surface in the vicinity of a folding blade housing groove opening formed at an opening of the groove.

4. The grip for a cutting tool according to claim 3, wherein
the grip body is configured as a part of a handle body for a cutting tool made of metal, the handle body having a U-shaped cross section, the grip body constituting a prescribed region in a longitudinal direction of the handle body, and
the pair of body side sections of the grip body are configured to bulge laterally as compared with the handle body in the vicinity thereof, and the fitting protrusions arranged at the respective open ends of the body side sections are configured to be tilted inward toward each other, such that the folding blade housing groove opening is narrower than the folding blade housing groove at the back of the opening.
